(19) United States
(12) Patent Application Publication
(10) Pub. No.: US 2014/0181710 A1
(43) Pub. Date: Jun. 26, 2014

(54) PROXIMITY LOCATION SYSTEM

(71) Applicant: HARMAN INTERNATIONAL INDUSTRIES, INCORPORATED, Stamford, CT (US)

(72) Inventors: Arvin Baalu, Bangalore (IN); Manu Malhotra, Bangalore (IN)

(73) Assignee: Harman International Industries, Incorporated, Stamford, CT (US)

(21) Appl. No.: 13/838,464

(22) Filed: Mar. 15, 2013

(30) Foreign Application Priority Data
Dec. 26, 2012 (IN) 5459/CHE/2012

(51) Int. Cl. G06F 3/0484

(52) U.S. Cl. CPC G06F 3/0484
USPC 715/765

(57) ABSTRACT

A proximity location system (PLS) can allow for a user to interact with a user interface without touching or speaking into the interface. The system may include or be in communication with the user interface, which may be a touchscreen, for example. The system may also include or be in communication with one or more sensors that can sense an object's size, shape, speed, and/or location with respect to the user interface. From these sensed object characteristics, the system can determine the sensed object's type, feature, and/or state; and from that determination, the system can direct the interface and/or a device in communication with the interface to take an action.

### PRIORITY CLAIM

This application claims the benefit of priority from Indian Provisional Patent Application No. 5459/CHE/2012, filed Dec. 26, 2012, which is incorporated by reference.

### BACKGROUND

1. Technical Field

The present disclosure relates to proximity location systems associated with user interfaces, such as hardware user interfaces and/or graphical user interfaces.

2. Background Art

A proximity location system can detect when an object is proximate to a device associated with the system, and from the detection can determine an action. For example, smartphones may be equipped with a proximity location system that can detect when the phone has been raised to a person's ear so as to initiate a phone call.

### SUMMARY

A proximity location system (PLS) may allow a user to interact with a user interface without touching or speaking into the interface. The PLS may include or be in communication with the user interface. The PLS may also include or be coupled with one or more sensors, such as proximity sensors, that can sense an object, such as a hand, a finger, or a stylus, proximate to the interface. For example, the PLS may be included in a device, such as a smartphone or a vehicle head unit, that includes a user interface and one or more sensors.

The sensor(s) may sense an object's size, shape, structure, composition, texture, movement, and/or location with respect to the user interface, for example. In one case, the system can determine whether the sensed object has columnar characteristics, and can determine an approximate radius of the sensed object. From this radius, for example, an object feature, state, and/or type can be determined. For example, the system can determine whether the sensed object is a stylus or a finger of a user, and whether the sensed object is approaching or moving away from the user interface.

Also, for example, from determining the feature, state, and/or type of the object, the system can direct the interface and/or a device in communication with the interface to take an action. For example, gestures with a hand, finger, or stylus of a user can be detected and interpreted as input for the user interface and/or a device in communication with the interface, and an action can result accordingly.

Other systems, methods, features and advantages will be, or will become, apparent to one with skill in the art upon examination of the following figures and detailed description. It is intended that all such additional systems, methods, features and advantages be included within this description, be within the scope of the system, and be protected by the following claims.

### BRIEF DESCRIPTION OF THE DRAWINGS

The system, such as a proximity location system (PLS), may be better understood with reference to the following drawings and description. The components in the figures are not necessarily to scale, emphasis instead being placed upon illustrating the principles of the system. Moreover, in the figures, like referenced numerals designate corresponding parts throughout the different views.

FIG. 1 illustrates an example block diagram of an example electronic device that may include one or more aspects of an example PLS.

FIG. 2 illustrates an example operational flowchart that can be performed by one or more aspects of an example PLS, such as the one or more aspects of the electronic device of FIG. 1.

FIGS. 3-8 illustrate an example object, such as a finger, interacting with an example user interface and one or more example sensors included or in communication with an example PLS.

FIGS. 9 and 10 also illustrate an example object, such as a finger, interacting with an example user interface and one or more example sensors included or in communication with an example PLS.

### DETAILED DESCRIPTION

It is to be understood that the following description of examples of implementations are given only for the purpose of illustration and are not to be taken in a limiting sense. The partitioning of examples in function blocks, modules or units illustrated in the drawings is not to be construed as indicating that these function blocks, modules or units are necessarily implemented as physically separate devices or a single physical device. Functional blocks, modules or units illustrated or described may be implemented as separate devices, circuits, chips, functions, modules, or circuit elements. One or more functional blocks, modules, or units may also be implemented in a common circuit, chip, circuit element or device.

Described herein is a proximity location system (PLS) included or in communication with a user interface. The user interface may be, include, or be in communication with any type of hardware user interface, such as an electronic display, touchscreen, keyboard, or keypad. Additionally or alternatively, the user interface may be, include, or be communicatively coupled with a graphical user interface (GUI). The PLS may also include or be in communication with one or more sensors, such as proximity sensors, that can sense an object's size, shape, movement, and/or location with respect to the user interface. The object may be or include a hand, a finger, or a stylus. The stylus may include electronic and/or mechanical components. The one or more sensors may include capacitive sensors, capacitive displacement sensors, Doppler effect sensors, Eddy-current sensors, inductive sensors, laser rangefinder sensors, magnetic sensors (such as magnetic proximity fuse sensors), passive optical sensors, passive thermal infrared sensors, photocell (or reflective) sensors, and ultrasonic sensors, for example.

The PLS may be or include embedded hardware and/or software in an electronic device, such as a smartphone, personal computer, or vehicle head unit, in communication with or including a user interface. Additionally or alternatively, the PLS may be embedded in another electronic device that communicates with the electronic device in communication with or including the user interface. The communication between these devices may be over a network, such as a local area or wide area network (LAN or WAN).

In one example, the PLS can determine whether the sensed object has columnar characteristics and/or whether the sensed object is taller than it is wide. This determination can be based on information associated with the sensed object sensed from the one or more sensors. Additionally or alternatively, from the sensed information, one or more lengths, widths, radiuses, circumferences, and other dimensions of the sensed object can be determined. From one or more of the measured dimensions of the sensed object, the PLS may determine a type, feature, and/or state of the sensed object. For example, the system can determine whether the sensed object is a stylus or a finger of a user. The system can also determine whether the sensed object includes a composition, a texture, a structure, or a shape. Also, for example, one or more locations or movement characteristics of the sensed object can be determined with respect to the user interface. For the type, feature, and/or state of the sensed object, the PLS can direct the user interface and/or a device in communication with the interface to take an action.

Also, another possible factor in determining the instructions to the interface and/or a device in communication with the interface may include the type of the user interface and/or a type of the device in communication with the interface.

The basis for the instructions to the interface and/or a device in communication with the interface may also be whether the sensed object is a valid object type and/or an authenticated object. This may be a beneficial safety feature, especially when the user interface is part of a vehicle.

In one example of the PLS, an aspect, such as a processor, performs determinations of an object type, feature, and/or state of the sensed object and/or validation or authentication of the sensed object based on one or more aspects of received information associated with the sensed object. In other words, the determinations, the validation, and the authentication may be facilitated by one or more aspects of the received information. The received information may include dimensions of the sensed object, speeds, accelerations, and/or directions of movement of the sensed object, and/or locations of the sensed object relative to other objects and devices, for example.

Additionally, an aspect of the PLS may perform an action based on the determinations of the object's type, the object's feature, the object's state, and/or the one or more of a validation or an authentication of the sensed object. Also, the PLS may perform an action based on a predicted point of contact of the sensed object with the user interface. This predicted point of contact may be determined by a processor of the PLS and may be determined to be a point with a very small circumference, such as a circumference less than a millimeter.

The object type of an object may be any categorization of an object. For example, an object type may include a product category of an object and/or manufacturer of the object. For example, the object type of an object may be a stylus that is manufactured by a certain company. The object type may also include a version of an object. For example, the object type may include a proprietary version of an object, such as version “2.0”, or “limited edition”, for example. The object type may also include a category of a product. For example, the object type may be a stylus of the beveled-end variety. The object type may also be a person or a part of a person, such as a face, hand, or digit of a person.

The object feature may include one or more of a composition, a texture, a structure, or a shape of an object or a part of an object. For example, where the object type is a finger, the composition may be different types of human tissue. The texture may include one or more colors of a part of the finger. The texture may also include an amount of ridges or shapes of ridges on a surface of a part of a finger. The structure and shape of a finger may include various dimensions of different parts of the finger and how the parts are joined, for example. The object feature may also include unique marks. In the finger example, a unique mark may include a scar and/or ridge pattern.

The object state may include a speed, acceleration, and/or direction of movement of the sensed object with respect to the user interface, for example. The object state may also include whether the sensed object is active, such a powered-on, or whether the sensed object is processing, inputting, or outputting information to another device, for example.

A validation of an object may include an aspect of the PLS, such as a processor, validating the sensed object. For example, one or more sensors in communication with the PLS may sense validation characteristics of the sensed object, and a processor of the PLS may determine whether the sensed object is valid for use with the PLS based on those validation characteristics. The validation characteristics may include physical attributes of the sensed object or a barcode or another form of identification of the sensed object or the object type of the sensed object. For example, where the sensed object is a hand, validation characteristics of a hand may be physical attributes, such one or more fingerprints, dimensions, or temperatures of the hand. For a finger, such characteristics may include one or more unique marks, such as scars or ridge patterns. Validating a hand or finger may be a useful safety or security feature. For example, the PLS may be set so an object of certain dimensions or smaller is invalid; such as dimensions of a child's finger or a writing utensil, such as a pen or pencil, being too small to be validated. Also, a notification of an invalid and/or an unauthenticated attempt to use the user interface may be displayed by the user interface and/or communicated by a communication interface of the PLS to an electronic device. Displaying the notification on the user interface may be useful in preventing scratches from writing utensils.

Additionally or alternatively, for example, the PLS may receive information from a communication with the sensed object, such as an optical or electromagnetic wireless communication, that includes data associated with the validation characteristics; and the validation of the sensed object may be based on that data.

An authentication of an object may include an aspect of the PLS, such as a processor, authenticating the sensed object. For example, one or more sensors in communication with the PLS may sense authentication information, such as a username and password associated with the sensed object, and the processor may determine whether the authentication information is authentic for the sensed object and/or the PLS. This determination may be based on matching the sensed authentication information against authentication information in a database associated with the PLS. Additionally or alternatively, for example, the PLS may receive information from a communication with the sensed object, such as an optical or electromagnetic wireless communication, that includes data associated with the authentication information; and the authentication of the sensed object may be based on that data.

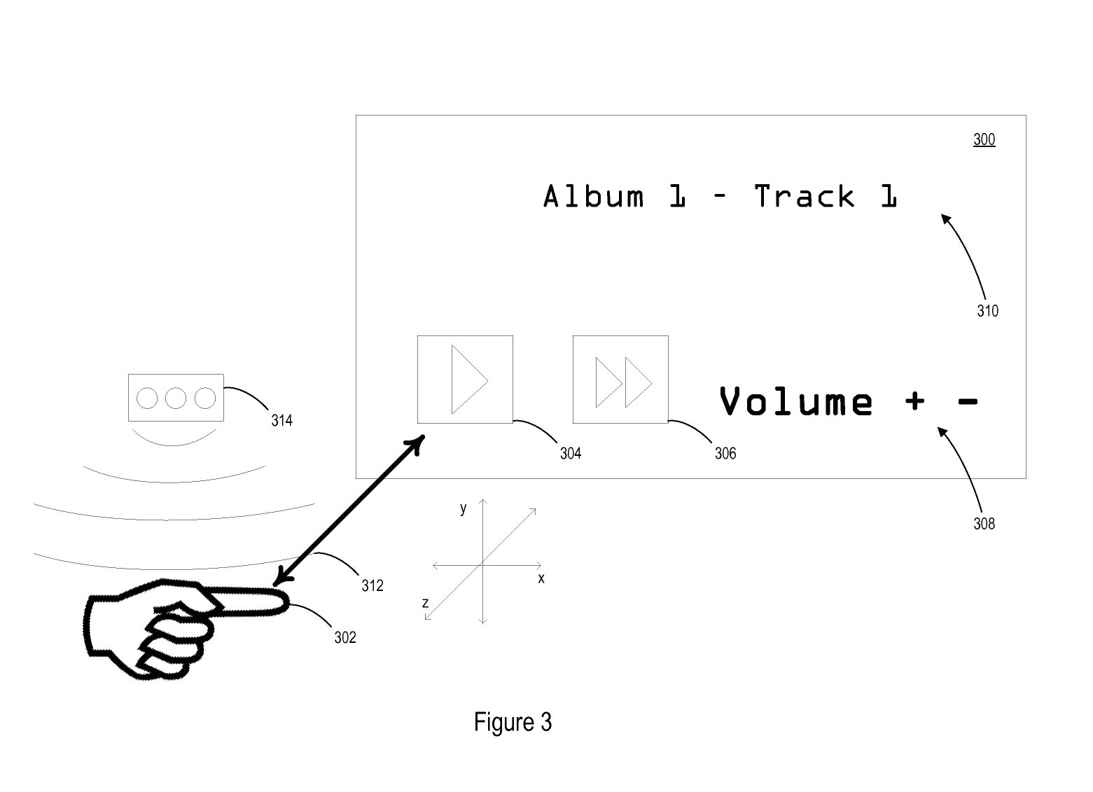

Additionally or alternatively, the system can base the action on motion of the sensed object in various directions, such as three-dimensional directions made up of x-, y-, and z-components and/or angular components. For example, gestures with a hand, finger, or stylus of a user that do or do not include touching the interface can be detected and interpreted as input for the user interface and/or a device in communication with the user interface. In one example PLS, the action can include enlarging a user interface element, such as a portion, graphical element (such as a displayed list or menu item), or icon displayed on a graphical user interface (GUI), in response to a sensed object, such as a finger or stylus of a user, approaching the user interface element. For example, a portion of a GUI may enlarge as the sensed object approaches a center point of that portion. In other words, a zoom function may be activated and controlled by moving the sensed object towards or away from a point and/or portion of a GUI, along a z-axis for example. The z-axis being perpendicular relative to x- and y-axes that span the width and height of the user interface, such as a touchscreen, for example (See FIGS. 3-10).

Additionally or alternatively, based on one or more of the determinations of the PLS, the system can direct the user interface and/or a device in communication with the interface whether to take an anticipated action or not. For example, in a GUI, one or more graphical elements, such as one or more buttons or items in a displayed list, may be expected to be selected according to historical information stored in memory, and the selection may occur based on the one or more determinations of the PLS.

Also, in one example PLS, the PLS may identify via the one or more sensors, an object within close proximity to the interface. Upon identifying the sensed object, the PLS may receive information pertaining to the sensed object's shape, size, speed, acceleration, and/or location and/or direction of movement with respect to the user interface. Using this information, the PLS may determine the object type, feature, and/or state of the sensed object. For example the PLS may determine the sensed object is a stylus approaching the interface at an approximate determined speed from an approximate determined angle with respect to the user interface. Also, the PLS may determine that the sensed object is approaching a user interface element, such as a portion, graphical element, or icon displayed on a GUI. Upon such a determination, the PLS may instruct the user interface to increase the size of the user interface element. Such a user interface element may also be emphasized by changing another parameter besides size, such as resolution, color, contrast, hue, or brightness of the user interface element.

In one example PLS, the resulting action may include actions associated with a user interface of a vehicle. For example, the PLS may be implemented with a vehicle information system, and proximate interactions with the user interface of the vehicle may cause the PLS to instruct actions performed by a vehicle information system, such as changing audio playback or climate inside a cabin of the vehicle. Such an interface may include an electronic display, a touchscreen, or a control panel of a head unit of a vehicle; or an interface embedded in a steering wheel or door control panel, for example.

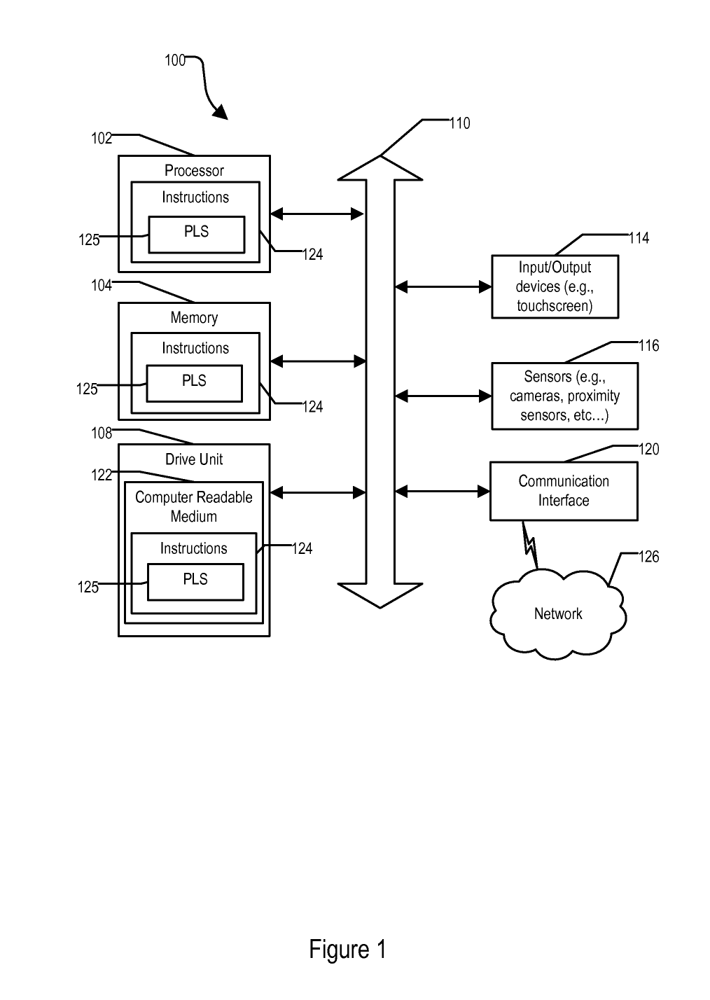

FIG. 1 is a block diagram of an example electronic device 100 that may include one or more aspects or modules of an example PLS. The electronic device 100 may include a set of instructions that can be executed to cause one or more modules of the electronic device 100 to perform any of the methods and/or computer based functions disclosed herein, such as locating an object proximate to a user interface, and taking or instructing an action based on the sensed object's shape, size, speed, acceleration, location, and/or direction of movement with respect to the user interface. The electronic device 100 may operate as a standalone device, may be included as functionality within a device also performing other functionality, or may be in communication with, such as using a network, to other computer systems, devices, or peripheral devices.

In the example of a networked deployment, the electronic device 100 may operate in the capacity of a server or a client user computer in a server-client user network environment, as a peer computer system in a peer-to-peer (or distributed) network environment, or in various other ways. The electronic device 100 can also be implemented as, or incorporated into, various electronic devices, such as hand-held devices such as smartphones and tablet computers, portable media devices such as recording, playing, and gaming devices, household electronics such as smart appliances and smart TVs, set-top boxes, automotive electronics such as head units and navigation systems, or any other machine capable of executing a set of instructions (sequential or otherwise) that result in actions to be taken by that machine. The electronic device 100 may be implemented using electronic devices that provide voice, audio, video and/or data communication. While a single device 100, such as an electronic device, is illustrated, the term “device” may include any collection of devices or sub-devices that individually or jointly execute a set, or multiple sets, of instructions to perform one or more functions. The one or more functions may include locating objects and/or people in a target environment, such as inside a vehicle, and changing one or more aspects of the environment and/or user interface in the environment, such as audio output signals or graphical user interface elements, based at least on information associated with one or more features, classifications, and/or states of the sensed objects and/or people.

The electronic device 100 may include a processor 102, such as a central processing unit (CPU), a graphics processing unit (GPU), or both. The processor 102 may be a component in a variety of systems. For example, the processor 102 may be part of a head unit in a vehicle. Also, the processor 102 may include one or more general processors, digital signal processors, application specific integrated circuits, field programmable gate arrays, servers, networks, digital circuits, analog circuits, combinations thereof, or other now known or later developed devices for analyzing and processing data. The processor 102 may implement a software program, such as code generated manually or programmed.

The electronic device 100 may include memory, such as a memory 104 that can communicate via a bus 110. The memory 104 may be or include a main memory, a static memory, or a dynamic memory. The memory 104 may include any non-transitory memory device. The memory 104 may also include computer readable storage media such as various types of volatile and non-volatile storage media including random access memory, read-only memory, programmable read-only memory, electrically programmable read-only memory, electrically erasable read-only memory, flash memory, a magnetic tape or disk, optical media and the like. Also, the memory may include a non-transitory tangible medium upon which software may be stored. The software may be electronically stored as an image or in another format (such as through an optical scan), and compiled, or interpreted or otherwise processed.

In one example PLS, the memory 104 may include a cache or random access memory for the processor 102. In alternative examples, the memory 104 may be separate from the processor 102, such as a cache memory of a processor, the system memory, or other memory. The memory 104 may be or include an external storage device or database for storing data. Examples include a hard drive, compact disc (CD), digital video disc (DVD), memory card, memory stick, floppy disc, universal serial bus (USB) memory device, or any other device operative to store data. For example, the electronic device 100 may also include a disk or optical drive unit 108. The drive unit 108 may include a computer-readable medium 122 in which one or more sets of software or instructions, such as the instructions 124, can be embedded. The processor 102 and the memory 104 may also include a computer-readable storage medium with instructions or software.

The memory 104 may be operable to store instructions executable by the processor 102. The functions, acts or tasks illustrated in the figures or described may be performed by the programmed processor 102 executing the instructions stored in the memory 104. The functions, acts or tasks may be independent of the particular type of instructions set, storage media, processor or processing strategy and may be performed by software, hardware, integrated circuits, firmware, microcode and the like, operating alone or in combination. Likewise, processing strategies may include multiprocessing, multitasking, parallel processing and the like.

The instructions 124 may include the methods and/or logic described herein, including aspects or modules of the electronic device 100 and/or an example proximity location system (such as PLS module 125). The instructions 124 may reside completely, or partially, in the memory 104 or in the processor 102 during execution by the electronic device 100. For example, software aspects or modules of the PLS (such as the PLS module 125) may include examples of various sensed object information processors that may reside completely, or partially, in the memory 104 or in the processor 102 during execution by the electronic device 100.

With respect to various sensed object information processors (or signal processors) that may be used by the PLS, hardware or software implementations of such processors may include analog and/or digital signal processing modules (and analog-to-digital and/or digital-to-analog converters). The analog signal processing modules may include linear electronic circuits such as passive filters, active filters, additive mixers, integrators and delay lines. Analog processing modules may also include non-linear circuits such as compandors, multiplicators (frequency mixers and voltage-controlled amplifiers), voltage-controlled filters, voltage-controlled oscillators and phase-locked loops. The digital or discrete signal processing modules may include sample and hold circuits, analog time-division multiplexers, analog delay lines and analog feedback shift registers, for example. In other implementations, the digital signal processing modules may include ASICs, field-programmable gate arrays or specialized digital signal processors (DSP chips). Either way, such digital signal processing modules may enhance an image signal via arithmetical operations that include fixed-point and floating-point, real-valued and complex-valued, multiplication, and/or addition. Other operations may be supported by circular buffers and/or look-up tables. Such operations may include Fast Fourier transform (FFT), finite impulse response (FIR) filter, Infinite impulse response (IIR) filter, and/or adaptive filters.

The modules described herein may include software, hardware, firmware, or some combination thereof executable by a processor, such as processor 102. Software modules may include instructions stored in memory, such as memory 104, or another memory device, that may be executable by the processor 102 or other processor. Hardware modules may include various devices, components, circuits, gates, circuit boards, and the like that are executable, directed, or controlled for performance by the processor 102. The term “module” may include a plurality of executable modules.

Further, the electronic device 100 may include a computer-readable medium that may include the instructions 124 or receives and executes the instructions 124 responsive to a propagated signal so that a device in communication with a network 126 can communicate voice, video, audio, images or any other data over the network 126. The instructions 124 may be transmitted or received over the network 126 via a communication port or interface 120, or using a bus 110. The communication port or interface 120 may be a part of the processor 102 or may be a separate component. The communication port or interface 120 may be created in software or may be a physical connection in hardware. The communication port or interface 120 may be configured to connect with the network 126, external media, one or more input/output devices 114, one or more sensors 116, or any other components in the electronic device 100, or combinations thereof. The connection with the network 126 may be a physical connection, such as a wired Ethernet connection or may be established wirelessly. The additional connections with other components of the electronic device 100 may be physical connections or may be established wirelessly. The network 126 may alternatively be directly in communication with the bus 110.

The network 126 may include wired networks, wireless networks, Ethernet AVB networks, a CAN bus, a MOST bus, or combinations thereof. The wireless network may be or include a cellular telephone network, an 802.11, 802.16, 802.20, 802.1Q or WiMax network. The wireless network may also include a wireless LAN, implemented via WI-FI or BLUETOOTH technologies. Further, the network 126 may be or include a public network, such as the Internet, a private network, such as an intranet, or combinations thereof, and may utilize a variety of networking protocols now available or later developed including TCP/IP based networking protocols. One or more components of the electronic device 100 may communicate with each other by or through the network 126.

The one or more input/output devices 114 may be configured to allow a user to interact with any of the components of the electronic device. Such devices may be or be in communication with the user interfaces described herein. The one or more input/out devices 114 may include a keypad, a keyboard, a cursor control device, such as a mouse, or a joystick. Also, the one or more input/out devices 114 may include a microphone, one or more visual displays, speakers, remote controls, touchscreen displays, or any other devices operative to interact with the electronic device 100, such as any device operative to act as an interface between the electronic device and one or more users and/or other electronic devices. Furthermore, as described throughout this disclosure, the input/output devices 114 may operate in conjunction with one or more sensors to enhance a user experience via proximate interactions, which may include interactions, such as gestures, without physical contact with an input/output device.

The electronic device 100 may also include one or more sensors 116. The one or more sensors 116 may include the one or more proximity sensors, motion sensors, or cameras, for example. Functionally, the one or more sensors 116 may include one or more sensors that detect or measure, motion, temperature, magnetic fields, gravity, humidity, moisture, vibration, pressure, electrical fields, sound, or other physical aspects associated with a potential user or an environment proximate to the user.

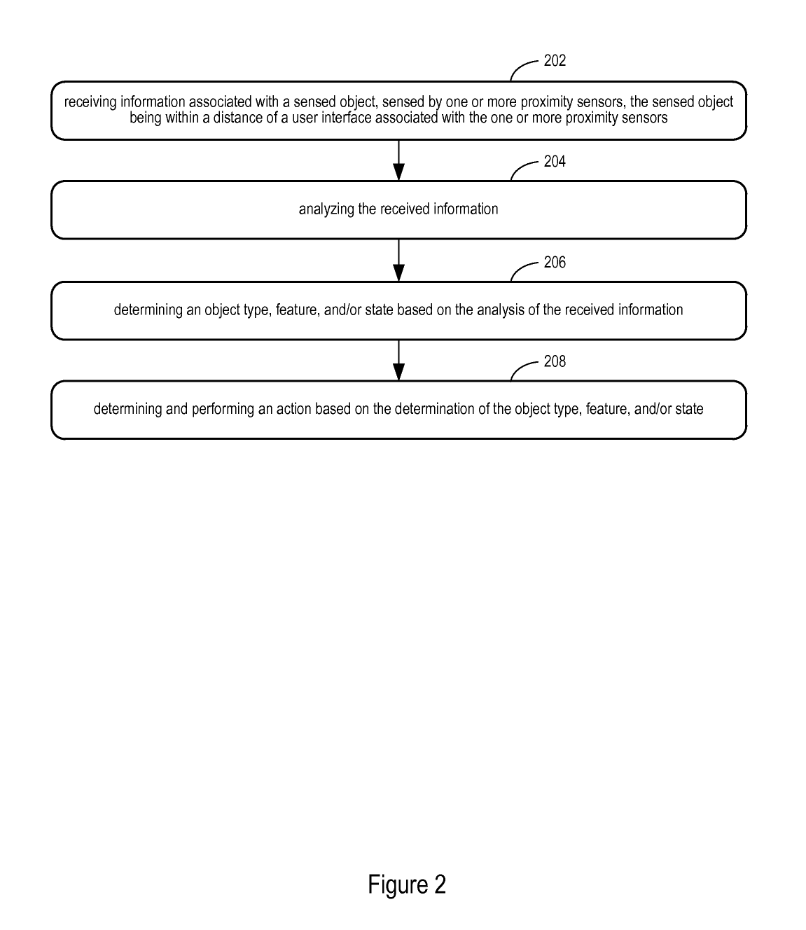

FIG. 2 illustrates an operational flowchart 200 that can be performed by one or more aspects of an example of the PLS, such as one or more aspects of the electronic device 100. The flowchart 200 represents example sub-processes for proximate object detecting, locating, characterizing, and sizing. Also, included are sub-processes for utilizing object information collected from the detecting, locating, characterizing, and sizing sub-processes. The characterizing sub-process may include determining one or more directions of movement and speeds of the sensed object. For example, determining a vector in which the sensed object is moving with respect to the interface and/or device in communication with the interface.

At 202, an aspect of the PLS may receive information associated with a sensed object, sensed by one or more sensors, the sensed object being within a distance of a user interface in communication with the one or more sensors (such as one or more cameras or proximity or motion sensors of the sensors 116 of FIG. 1). For example, the one or more sensors may sense an object, such as a stylus or human finger, when it hovers over a user interface, such as a touchscreen. In one example PLS, the one or more sensors may anticipate a touching of the interface before the touching occurs.

The one or more sensors may sense the size and shape of the sensed object, and the location of the sensed object with respect to the user interface, in a coordinate system, such as an x-, y-, and z-coordinate system. The x-, y-, and z-coordinate system or any other type of coordinate system of the PLS (such as an x- and y-coordinate system or a polar coordinate system) may include respective regions that may be associated with elements or portions of the user interface. In other words, a respective region of a plurality of regions proximate to the user interface may be associated with a respective user interface element, such as a respective portion, graphical element, or icon displayed on a GUI. For example, this allows for the elements or portions of the user interface to be emphasized (such as increased in size and/or brightness) as the sensed object enters the respective regions. Also, as the sensed object approaches a user interface element within a respective region of the coordinate system, the user interface element may be further emphasized as the sensed object moves closer to the user interface element.

At 204, an aspect of the PLS may analyze the information associated with the sensing of the object. This analysis may be performed by a processing aspect, such as the processor 102, to determine a possible intention of a user guiding the sensed object. For example, the processing aspect of the PLS may determine whether the user is attempting to touch a part of the user interface and/or make a gesture known to the PLS. In one example, known gestures may be stored in a database included or in communication with the PLS.

At 206, an aspect of the PLS may determine a feature, an object type of the sensed object, and/or its state (such as one or more of its speeds, accelerations, directions, or locations relative to the user interface) based on the analysis of the received information. The analysis of the received information may include comparing waveforms of the received information against known waveforms, such as waveforms stored in a database. The known waveforms, individually or in various combinations, may be representative of various respective objects, object features, object types, and/or object states.

At 208, an aspect of the PLS may determine and perform an action based on the determination of the object type, feature, and/or state. For example, based on x-, y-, and z-coordinates of the sensed object relative to a user interface element, a control aspect may instruct that element to change. In a GUI, the element can change in resolution, color, contrast, hue, brightness, shape, and/or size, for example. In one example PLS, where the sensed object is being detected as approaching an icon or region of a GUI, which may be a state of the sensed object, the icon or region can be emphasized (such as highlighted) upon detecting the sensed object within a particular distance from the icon or region. In addition, as the sensed object moves nearer the icon or region, the icon or region can increase in size. This functionality is especially useful in a control panel of a vehicle. Additionally or alternatively, angle, direction, speed, or acceleration of the sensed object approaching the icon or region of a GUI can be one or more factors of the sensed object's state in determining the resulting action or instruction to act. In addition, one or more of these factors may be indicative of a duration of time in which a proximate interaction with the user interface occurs. This duration of time may also be a factor used to base the resulting action.

In one example PLS, determining the action of the user interface is based on a radius of an aspect of the sensed object, which may represent a type, feature, and/or state of the sensed object. Additionally or alternatively, material of the sensed object may be determined, which is an example feature of the object. For example, it may be determined whether the sensed object is made up of metal, plastic, and/or human tissue. For example, a stylus held by a human hand may be detected, and such information may be used to determine the resulting action or instruction.

The processing aspect of the PLS may also instruct the user interface to return to a predetermined configuration, such as its arrangement, prior to the sensed object approaching the user interface. This event may occur after the sensed object has been removed from the proximity of the user interface and/or emphasized part of the user interface. Also, this may occur from the sensed object moving in a direction away from the user interface and/or emphasized part of the user interface.

Also, a speed in which the sensed object moves in a direction, which is an example state of the sensed object, may be a factor in determining the action. So moving the sensed object away from the user interface at a first speed may lead to the interface returning to a predetermined configuration prior to the sensed object approaching the interface. Whereas slowly moving the sensed object away from the user interface at a second speed may lead to an opposite but equal action. For example, where an object approaching an icon leads to the icon enlarging, slowly moving the sensed object away from the icon may lead to the icon shrinking. In addition, the degree in which the icon changes over time may be with respect to the speed in which the sensed object approaches or retreats from the icon or other type of graphical element such as a center point of a portion of a GUI. Such functionality may be useful in zooming in and out of maps of a navigation system, or browsing audio tracks via a head unit of a vehicle, for example. In the example of browsing audio tracks in a vehicle, a user may browse through tracks by moving his or her hand in a first direction at a first speed. In addition, the user may choose to play a track by moving his or her hand in a second direction at a second speed.

In FIGS. 3-8, depicted are one or more example sensors 314 (such as one or more cameras or proximity or motion sensors of sensors 116), an example object 302, such as a finger, and an example GUI 300, such as a GUI for audio playback control.

In FIGS. 3-8, the GUI includes a play-an-audio-track button 304, a forward-to-next audio-track button 306, a volume control 308, and an audio track indicator 310. As depicted in FIG. 3, the object 302 is a distance 312 from the GUI 300 and the play-an-audio-track button 304. At distance 312, the object 302 is not being sensed by the one or more sensors 314, or the PLS is deciding not to take any action even though the object is being sensed by the one or more sensors, for example.

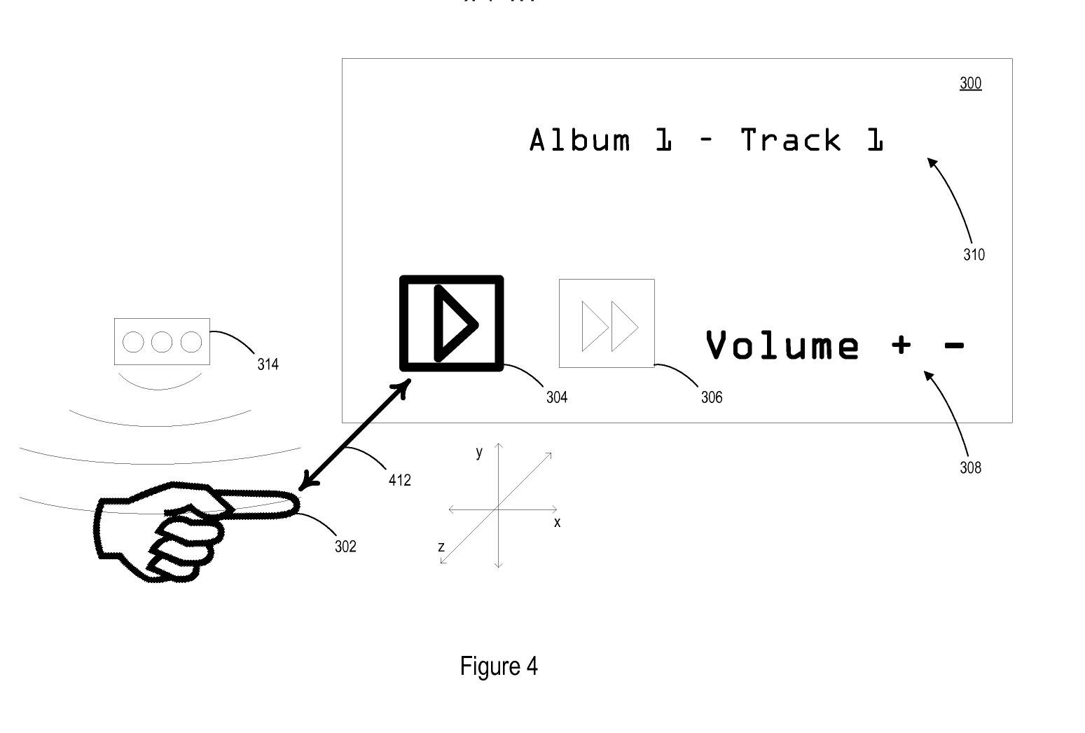

In FIG. 4, the GUI includes the same elements, but the play-an-audio-track button 304 is highlighted due to the object 302 approaching the button 304 along a vector, for example, and being within a predetermined distance 412 from the button 304. In this example, the distance 412 is less than the distance 312.

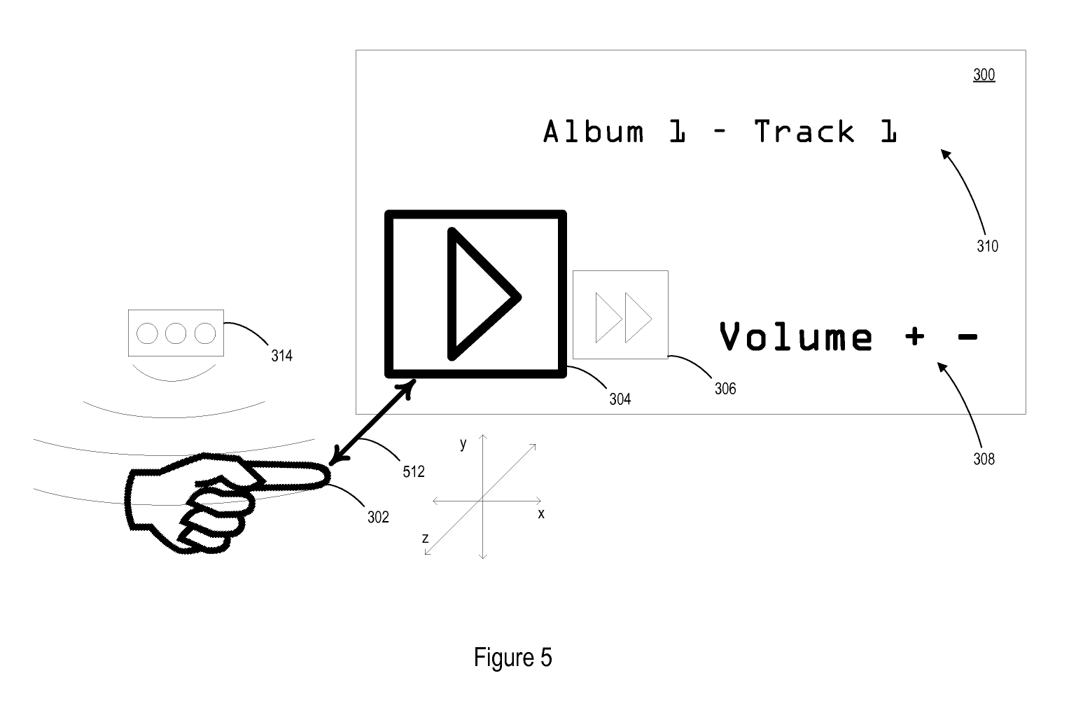

In FIG. 5, the GUI includes the same elements, but the play-an-audio-track button 304 is highlighted and enlarged (or just enlarged) due to the object 302 approaching the button 304 and being within a predetermined distance 512 from the button 304, which may be a state of the object. In this example, the distance 512 is less than the distance 412.

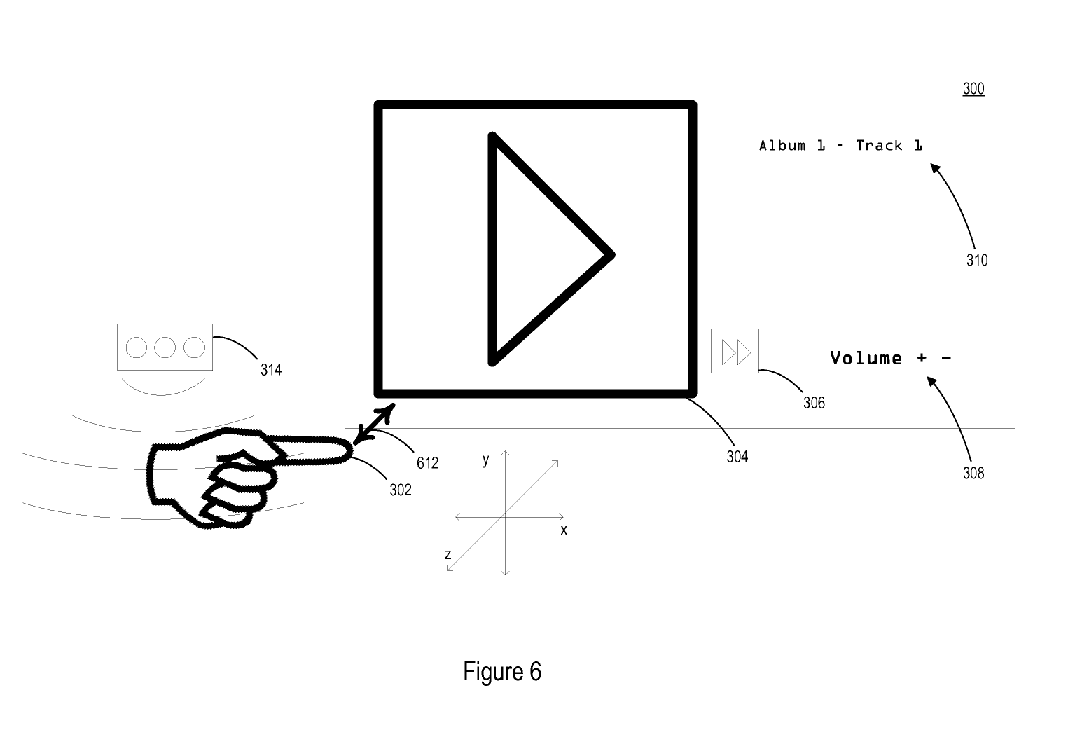

In FIG. 6, the GUI includes the same elements, but the play-an-audio-track button 304 is highlighted and enlarged (or just enlarged) more due to the object 302 approaching the button 304 and being within a predetermined distance 612 from the button 304. In this example, the distance 612 is less than the distance 512. Additionally or alternatively, the other elements of the GUI that are not being emphasized, such as highlighted and/or enlarged, may be deemphasized, such as shifted away from the middle of the user interface and/or made smaller. This additional or alternative feature makes it easier for the user to approach, eventually touch, or interact with the emphasized graphical element. This is especially useful when the GUI is in a moving vehicle, where it may be more difficult to steady the sensed object approaching the GUI.

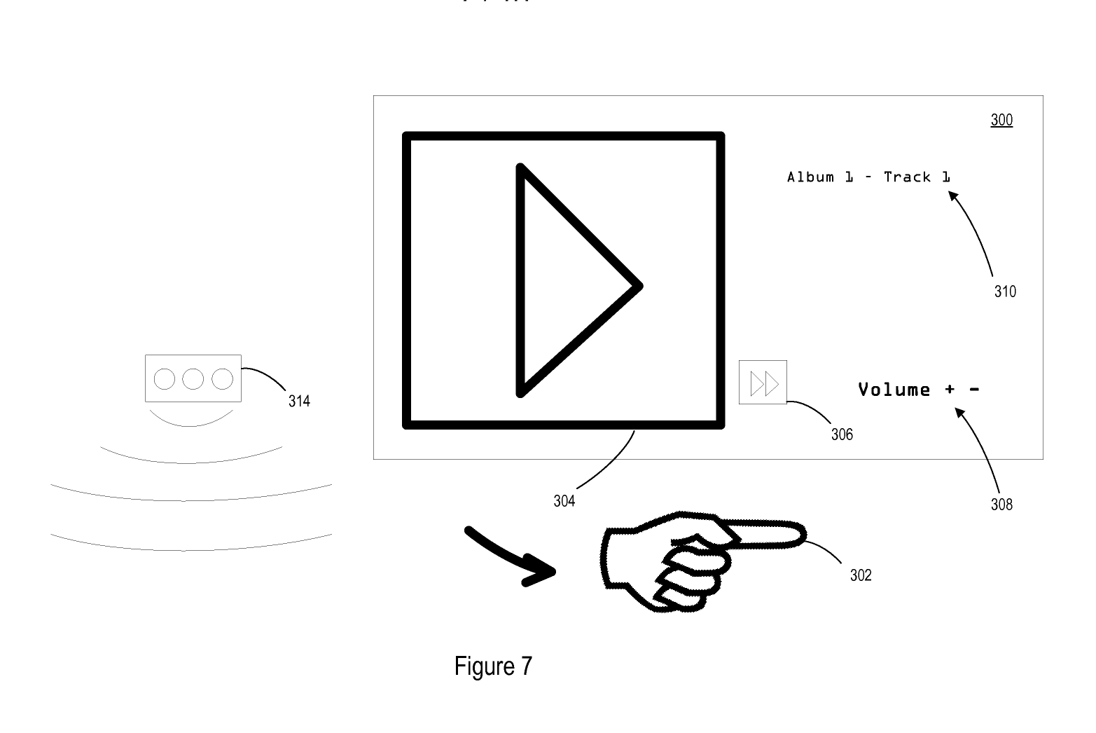

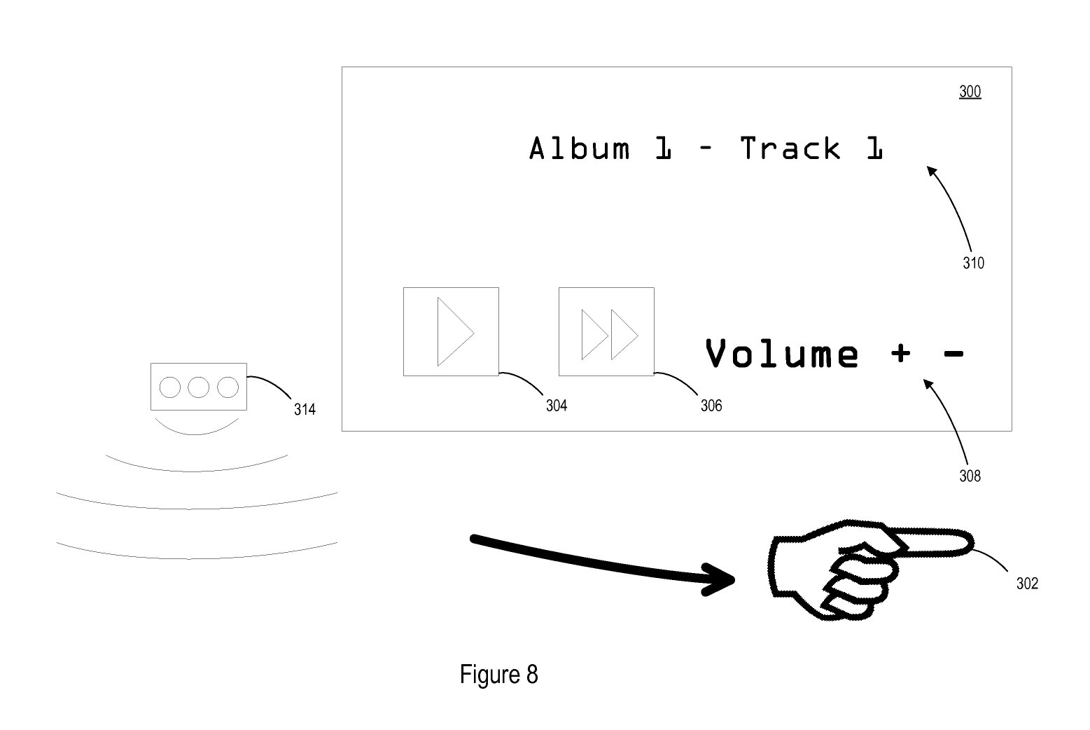

In FIG. 7, depicted is the object 302 moving away a first distance from the vector approaching the button 304. However, the first distance of movement away from the vector is not enough to alter the emphasis of the button 304. In FIG. 8, the object 302 has moved away a second distance from the vector approaching the button 304, which is enough to cause the GUI to return to the configuration illustrated in FIG. 3, for example, where none of the elements have been emphasized yet by instructions of the PLS.

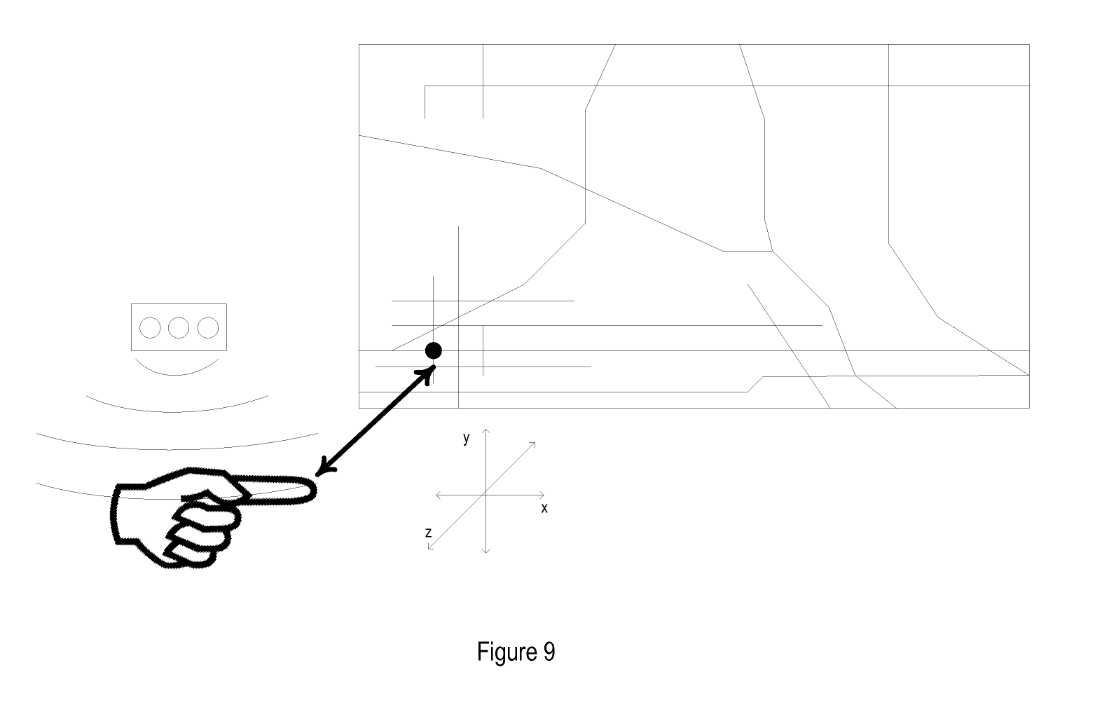

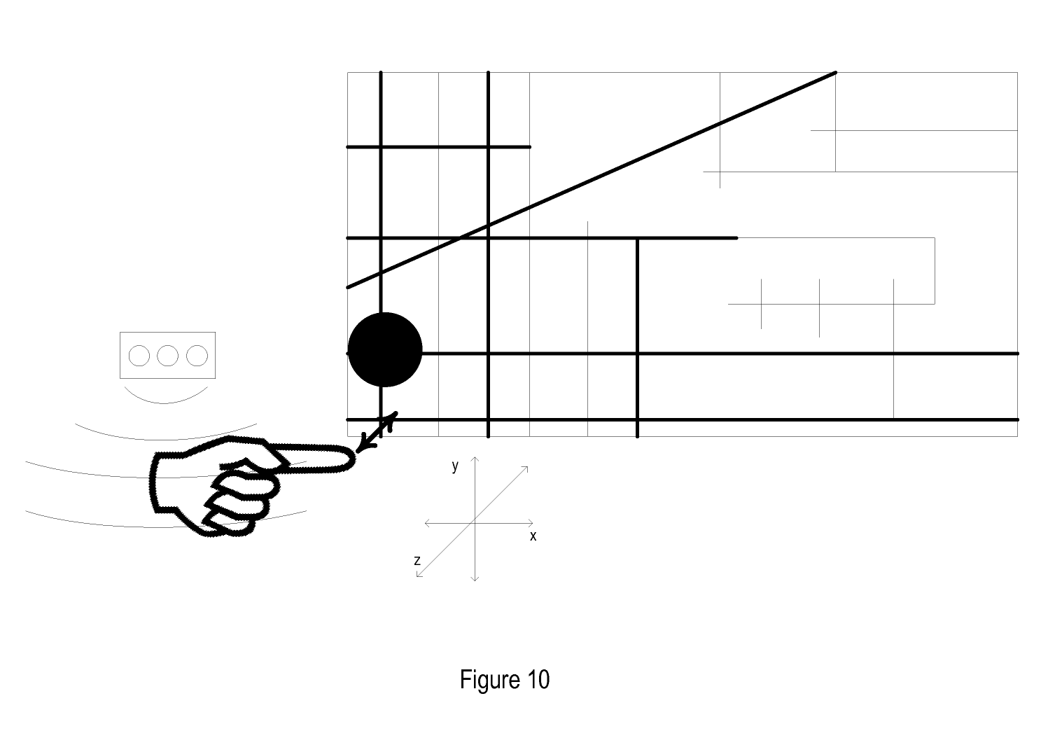

FIGS. 9 and 10 depict similar functionality as that illustrated in FIGS. 3-8, but with respect to a portion of a GUI, instead of with respect to an icon. In FIG. 9, a finger is at a first position and a first distance from a portion of the user interface, which may be a state of the finger, for example. In FIG. 10, the finger is at a second position and a second distance (which is less than the first distance) from the portion of the user interface. Movement of the finger from its position in FIG. 9 to its position in FIG. 10 may cause the GUI to zoom in on the portion of the GUI that the finger is moving towards. Whereas, movement of the finger from its position in FIG. 10 to its position in FIG. 9 may cause the GUI to zoom out of the portion that the finger is moving away from.

Additionally or alternatively, an example method of the PLS may include receiving information via a communication interface, the information associated with an object being sensed by one or more sensors, the sensed object being within a distance of a user interface in communication with the one or more sensors; analyzing via a processor, the received information; determining via the processor, an object type, feature, and/or state of the sensed object based on the analysis of the received information; and performing via the processor, an action based on the determination of the object type, feature, and/or state. The receive information may include one or more dimensions of the sensed object and the one or more dimensions facilitates the determination of one or more of the object type, feature, and/or state. The one or more dimensions may include a radius of the sensed object. The one or more dimensions may include one or more of length, width, or height of the sensed object. The received information may include one or more of speed or acceleration of the sensed object and the one or more of speed or acceleration may facilitate the determination of one or more of the object type, feature, and/or state. The received information may include one or more directions of movement of the sensed object and the one or more directions of movement may facilitate the determination of one or more of the object type, feature, and/or state. The received information may include the distance of the sensed object from one or more of the user interface, an element of the user interface, or a device in communication with the user interface, and one or more of the distances may facilitate the determination of one or more of the object type, feature, and/or state. The received information may include a duration of time in which the sensed object interacts proximately with the user interface and the duration of time may facilitate the determination of one or more of the object type, feature, and/or state. The action may include instructing the user interface via the processor, to change a user interface element based on a state of the sensed object. The changing the user interface element may include one or more of changing resolution, color, contrast, hue, or brightness of the user interface element. The changing of the user interface element may include changing size of the user interface element. The changing of the user interface element may include changing a shape of the user interface element. The changing of the user interface element may include zooming in on or zooming out of the user interface element. The one or more sensors may include one or more motion sensors, proximity sensors, or cameras. The user interface may be embedded in or communicatively coupled with a vehicle head unit. The received information may include data associated with a respective region of a plurality of regions proximate to the user interface, the respective region being associated with a respective user interface element.

Additionally or alternatively, the system may include: a communication interface operable to receive information associated with an object, the object being sensed by one or more sensors, and the sensed object being within a distance of a user interface in communication with the one or more sensors; and a processor operable to: analyze the received information; determine an object type, feature, and/or state of the sensed object based on the analysis of the received information; perform one or more of validation or authentication of the sensed object based on the received information; and perform an action based on the determination of the object type, feature, and/or state, and the one or more of the validation or the authentication of the sensed object. The sensed object may include validation characteristics that the one or more sensors sense, where the received information may include data associated with the validation characteristics, and where the validation may be based on the data associated with the validation characteristics. The sensed object may include authentication information that the one or more sensors sense, where the received information may include data associated with the authentication information, and where the authentication may be based on the data associated with the authentication information.

Additionally or alternatively, a computing device of the system may be operable to: receive information associated with an object, the object being sensed by one or more sensors, the sensed object being within a distance of a user interface in communication with the one or more sensors; analyze the received information; determine an object type, feature, and/or state of the sensed object based on the analysis of the received information; and determine whether to take an anticipated action or not, based on the determination of the object type, feature, and/or state.

While various embodiments of the system have been described, it will be apparent to those of ordinary skill in the art that many more embodiments and implementations are possible within the scope of the system. Accordingly, the invention is not to be restricted except in light of the attached claims and their equivalents.

We claim:

1. A method, comprising:
receiving, at a processor, information associated with an object sensed within a distance of a user interface;
identifying, by the processor, the sensed object based on the received information;
determining, by the processor, a feature of the identified object based on the received information; and
executing, by the processor, an action based on the determination of the feature.

2. The method of claim 1, where the feature includes one or more of a composition, a texture, a structure, or a shape of the sensed object.

3. The method of claim 1, where the received information includes one or more dimensions of the sensed object.

4. The method of claim 3, where the one or more dimensions of the sensed object include one or more of a radius, a circumference, a length, a width, or a height.

5. The method of claim 1, where the received information includes one or more visual surface characteristics of the sensed object.

6. The method of claim 1, where the received information includes one or more of a speed, an acceleration, or a direction of movement of the sensed object.

7. The method of claim 1, where the received information includes the distance of the sensed object from the user interface.

8. The method of claim 1, where the received information includes a duration of time in which the sensed object interacts with the user interface.

9. The method of claim 1, where the received information includes one or more visual characteristics of a person or a part of a person.

10. The method of claim 1, further comprising instructing, by the processor, the user interface to change a user interface element based on the determination of the feature of the identified object.

11. The method of claim 10, where the changing of the user interface element includes one or more of changing resolution, color, contrast, hue, or brightness of the user interface element.

12. The method of claim 10, where the changing of the user interface element includes changing one or more of a size or a shape of the user interface element.

13. The method of claim 1, further comprising instructing, by the processor, the user interface to zoom in on or zoom out of a user interface element based on the determination of the feature of the identified object.

14. The method of claim 1, where the received information includes data associated with a respective region included among a plurality of regions proximate to the user interface, the respective region being associated with a respective user interface element of the user interface.

15. A system, comprising
a communication interface operable to receive information associated with an object, the object being sensed by one or more sensors, the sensed object being within a distance of a user interface;
a processor communicatively coupled to the communication interface; and
memory communicatively coupled to the processor, the memory including instructions executable by the processor to:
identify the sensed object based on the received information;
determine an object type of the identified object based on the received information; and
perform an action based on the determination of the object type.

16. The system of claim 15, where the instructions are further executable by the processor to:
perform one or more of a validation or an authentication of the identified object based on the received information; and
perform an action based on the determination of the object type and the one or more of the validation or the authentication of the identified object.

17. The system of claim 15, where the identified object comprises authentication information that the one or more sensors sensed, and where authentication of the identified object is based on the authentication information.

18. The system of claim 15, where the identified object comprises validation characteristics that the one or more sensors sensed, and where validation of the identified object is based on the validation characteristics.

19. A method, comprising:
receiving, at a processor, information associated with an object sensed within a distance of a user interface;
identifying, by the processor, the sensed object based on the received information;
determining, by the processor, an object type associated with the identified object based on the received information; and
executing, by the processor, an action based on the determination of the object type.

20. The method of claim 19, further comprising:
determining, by the processor, an object state associated with the identified object based on the received information; and
executing, by the processor, the action based on the determination of the object type and the object state.
